(19) United States
(12) Patent Application Publication
(10) Pub. No.: US 2025/0354234 A1
(43) Pub. Date: Nov. 20, 2025

(54) DEVICE FOR PELLETIZING MATERIALS

(71) Applicants: Vale S.A., Rio de Janeiro, RJ (BR); Serviço Nacional de Aprendizagem Industrial, Departamento Regional da Bahia - SENAI/DR/BA, Salvador, BA (BR)

(72) Inventors: Alan Reisen CARDOZO, Vila Velha (BR); Ricardo Olympio DE FREITAS, Serra (BR); Frederico Correa MAYERHOFER, Vitória (BR); Luis Henrique Torres DANTAS, Serra (BR); Anísio Chagas Bernardino ALVES, Vitória (BR); Vinicius Perin PASSIGATTI, Vila Velha (BR); Victor Teixeira da Silva ARAGÃO, Salvador (BR); Rafael Nascimento BARROS, Salvador (BR); Manoel CARREIRA NETO, Salvador (BR); Antonio José Mendonça FERREIRA, Lauro de Freitas (BR); Marcelo Sousa DE CARVALHO, Salvador (BR); Matheus Dutra CALDAS, Salvador (BR); Ruan Feliz dos Santos BRASIL, Candeias (BR); Frederico Wergne de Castro ARAÚJO FILHO, Salvador (BR); Danilo Marques FERREIRA, Salvador (BR); Amanda DANTAS, Salvador (BR); Ebnezer Gomes CAVALCANTI NETO, Salvador (BR); Luiz Flávio DA SILVA, Lauro de Freitas (BR)

(21) Appl. No.: 18/872,729

(22) PCT Filed: Jun. 7, 2023
(86) PCT No.: PCT/BR2023/050188

§ 371 Date: Dec. 6, 2024

(30) Foreign Application Priority Data
Jun. 9, 2022 (BR) 1020220113840

(51) Int. Cl. C22B 1/24

(52) U.S. Cl. CPC C22B 1/2406

(57) ABSTRACT

The present invention describes a device for pelletizing materials comprising a tiltable pelletizing disc configured for rotation, and a plurality of adjustable scraping modules attachable to the pelletizing disc, wherein each adjustable scraping module of the plurality of adjustable scraping modules includes a scraping blade and is configured to rotate the scraping blade in three angular directions.

### TECHNICAL FIELD

The present invention relates to the field of devices for agglomerating materials. Specifically, the present invention relates to a device for pelletizing materials.

### DESCRIPTION OF PRIOR ART

In mining operations, the fine fractions of iron ore coming from mines are often ground with fluxes, such as dunite, magnesite, limestone, among others and subsequently receive a dosage of binder (for example, hydrated lime, bentonite, organic binder, etc.) with the purpose of agglutinating the microparticles.

To manufacture pellets, this previously homogenized mixture is subjected to the pelletizing process using equipment such as pelletizing discs or plates, where the microfine particles are agglomerated to form a substantially spherical pellet.

Subsequently, the pellets are classified in sieves to remove fines and coarse material, in which the fines and coarse material, after being disintegrated, return to the pelletizing discs, and the pellets already classified in the desired diameter are submitted to the sintering furnace for the respective hardening.

Pelletizing equipment can also be used to agglomerate or pelletize other materials, such as primary materials and also secondary materials, such as fertilizers, filter dust or other mixtures and waste materials to provide better handling and/or avoid segregation.

Pelletizing discs generally comprise a tiltable rotating plate that has inside a set of scrapers that stabilize the flatness and height of the bottom layer of the disc and direct the flow of the material being pelletized. Through the process of rolling and agglutination of particles, combined with the centrifugal force provided by the rotation of the plate, the diameter of the pellets is defined.

Pelletizing devices are known in the prior art. Document BR112012024643 (Bl) discloses a pelletizing device for pelletizing pelletizable materials, which comprises at least one pelletizing disc inclined with respect to the horizontal and rotatably provided, the pelletizing disc being driven by a motor device and in which the pelletizing disc has at least one bottom and at least one side wall, the bottom and the side wall creating a processing space, the size of which is changeable, in which an effective height of the side wall is changeable, in which the side wall comprises a internal sidewall device and an external sidewall device, wherein the internal sidewall device is arranged and its height can be adjusted in relation to the external sidewall device.

Document CN207153646 (U) describes a pelletizing device with adjustable scraper, consisting of a frame and a disk installed obliquely on the frame; the disk can rotate about its axis. The device also includes a drive mechanism to make the disk rotate and includes a beam arranged above the disk opening, which is fixedly connected to the frame; the beam is hollow and has a coaxial rotating shaft running through it. The ends of the beam are fixed with support arms and various adjustment holes are present on the support arm adjustment disk; the two support arms are fixedly connected to the two ends of the rotating shaft respectively. The two support arms are fixedly connected to the two ends of the rotating shaft respectively; the support arms are supplied with the corresponding adjustment holes. A connection hole and the adjustment hole can be connected by a pin shaft; the lower end of the support arm is provided with a scraper adjustment plate, and the adjustment hole distributed on the same circumference is opened in the scraper adjustment plate.

Document CA2411041 (C) discloses a groove-opening apparatus comprising a disk rotatably fixed to the apparatus, so that when the disk engages the ground, a groove is formed adjacent to a rear face of the disk. A scraper has a scraper blade oriented substantially parallel to the rear face of the disk and mounted so that the scraper blade is oriented close to or touching a lower portion of the rear face adjacent to an outer edge of the disk. The scraper is attached in an adjustable way to the device so that the scraper blade can be moved inwards along the back face of the disk as the disk wears while being kept substantially parallel to the back face of the disk and close to or touching the back face of the disk. A distribution tube for agricultural material can be attached to the device so that it moves in tandem with the scraper, and the scraper can be tilted against the face of the disk.

Document CN2325105 (Y) discloses a coating plate for rotating discs for granulating materials, suitable for disc ball machines in the metallurgical industry and the sintering industry. A mixer can be used as a coating for a base plate. A lining plate is made up of an outer ring lining plate, an inner ring lining plate and a central lining plate. Each portion is formed by combining a plurality of sector cladding plates with the same shapes, and the cladding plate is provided with a pattern formed by a groove or a concave recess. The groove can be linear, arc and prismatic reticular. The concave recess can be circular, oval, square or triangular.

As can be seen, none of the documents cited describes a device capable of providing precise control of the movement of the scrapers on the pelletizing disk and capable of reducing human intervention in the operation and maintenance of the disk.

### OBJECTS OF THE INVENTION

The object of the present invention is to provide a material pelletizing device configured to provide precise control of the movement of the scrapers over the pelletizing disk.

Another object of the present invention is to provide a material pelletizing device that can reduce human intervention in the operation and maintenance of the pelletizing disk.

### BRIEF DESCRIPTION OF THE INVENTION

The present invention discloses a materials pelleting device comprising a tiltable and rotatably provided pelleting disk and a plurality of adjustable scraper modules attachable to the pelleting disk, wherein each adjustable scraper module of the plurality of adjustable scraper modules includes a scraper blade and is configured to rotate the scraper blade in three angular directions.

### BRIEF DESCRIPTION OF THE FIGURES

Figures of the material pelletizing device are briefly described as follows:

FIG. 1-Schematic views of a material pelletizing device;

FIG. 2-Schematic views of the material pelletizing device including a trestle for installing adjustable scraper modules;

FIG. 3-Schematic view of a material pelletizing device discharge ramp;

FIG. 4-Schematic views of a plate of polymer spheres mounted on metal bars and a plurality of plates applied to a pelletizing disk of the pelletizing device;

FIG. 5-Schematic views of an adjustable scraper module of the material pelletizing device;

FIG. 6-Schematic view of the sacrificial device for monitoring scraping stone wear.

FIG. 7-Schematic views of a housing and table of the adjustable scraper module of the material pelletizing device;

FIG. 8-Schematic views of a scraper head and blade of the adjustable scraper module of the material pelletizing device;

FIG. 9-Schematic view of an adjustable scraper module and the rack of the material pelletizing device;

FIG. 10-Schematic views of a roller sieve and a deflector element of the material pelletizing device;

FIG. 11-Schematic views of the roller screen of the material pelletizing device; and

FIG. 12-Schematic view of the material pelletizing device including access platforms.

### DETAILED DESCRIPTION OF THE INVENTION

The following description is based on a preferred embodiment of the invention, applied to a device for pelletizing materials.

The present invention provides a material pelleting device comprising a tiltable and rotatably provided pelleting disc and a plurality of adjustable scraper modules attachable to the pelleting disc, wherein each adjustable scraper module of the plurality of adjustable scraper modules includes a scraper blade and is configured to rotate the scraper blade in three angular directions.

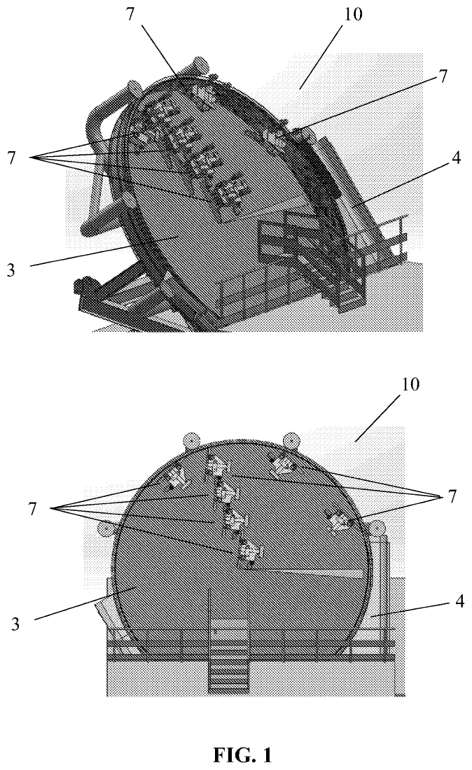

An example of a material pelleting device is illustrated in FIG. 1. The material pelletizing device 10 includes a pelletizing disk 3. The inclination of the pelletizing disk 3 is adjustable and it is set to rotate around its own axis during operation.

The material pelletizing device 10 comprises a plurality of adjustable scraper modules 7 attachable to the pelletizing disk 3 and a discharge ramp 4. In this embodiment, the pelletizing disc 3 comprises 2 to 10 adjustable scraper modules 7. Preferably, the plurality of adjustable scraper modules 7 comprise 7 adjustable scraper modules 7.

In this preferred embodiment, the adjustable scraper modules 7 are electro-mechanical modules that control the movement of the scraper blades 16 through angular adjustments, which individually control the height, level and top angle of each scraper blade 16. through a set of linear actuators 12.

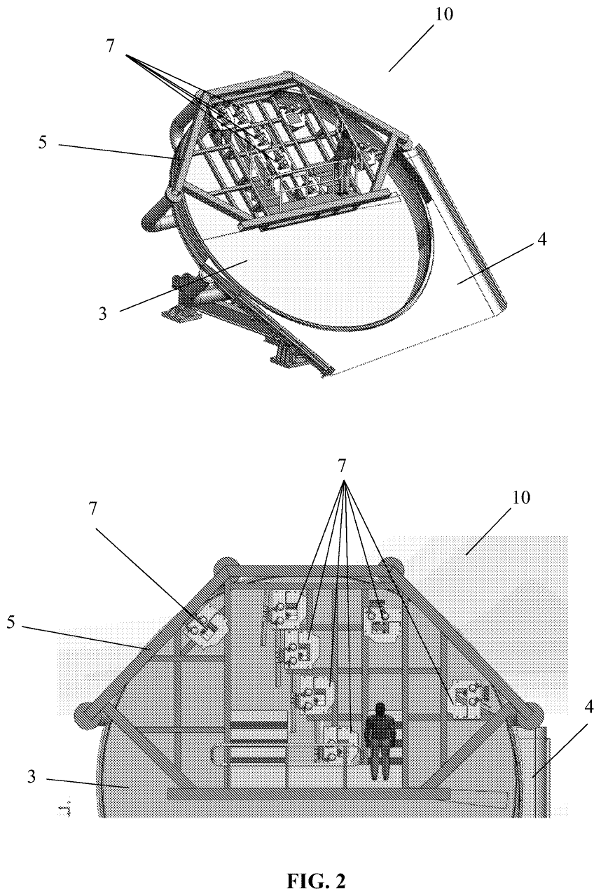

FIG. 2 schematically illustrates the material pelletizing device 10 with a trestle 5 to accommodate the adjustable scraper modules 7 and being attachable to the pelletizing disk 3. Preferably, the trestle 5 comprises a metal structure made up of welded profiles and can be attached to the pelletizing disk 3 by means of flanges.

The trestle 5 can include a walkway for access to the adjustable scraper modules 7. The trestle 5 is also configured to support the electrical connectors of the adjustable scraper modules 7. This easel 5 allows employees to access the adjustable scraper modules 7 during maintenance of these components, allowing them to be guided and positioned during replacements.

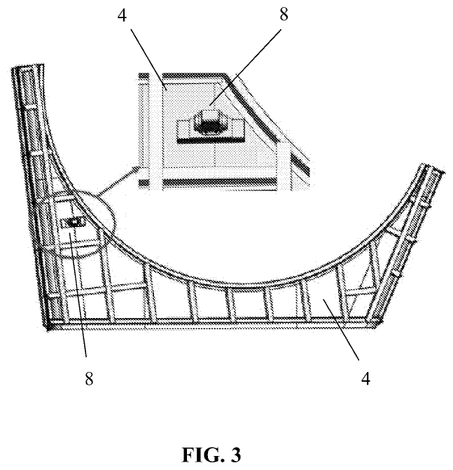

FIG. 3 shows discharge ramp 4 schematically. The discharge ramp 4 is made of sheet metal, preferably stainless steel to reduce adhesion and abrasion of the material slurry. Still in its preferred configuration, discharge ramp 4 is made up of just two metal sheets joined together, in order to reduce the number of edges on this component and, consequently, the points of adhesion of the material slurry. In order to prevent the material slurry from adhering to the discharge ramp 4, the screws used to fix the metal sheets must have a flat head.

To help reduce the adhesion of the material slurry, the discharge ramp 4 includes a motor vibrator 8 installed in the area where adhesion occurs most. The vibrations induced by the motorized vibrator 8 on the discharge ramp 4 remove the slurry of material adhered to the discharge ramp 4 during the pelletizing process.

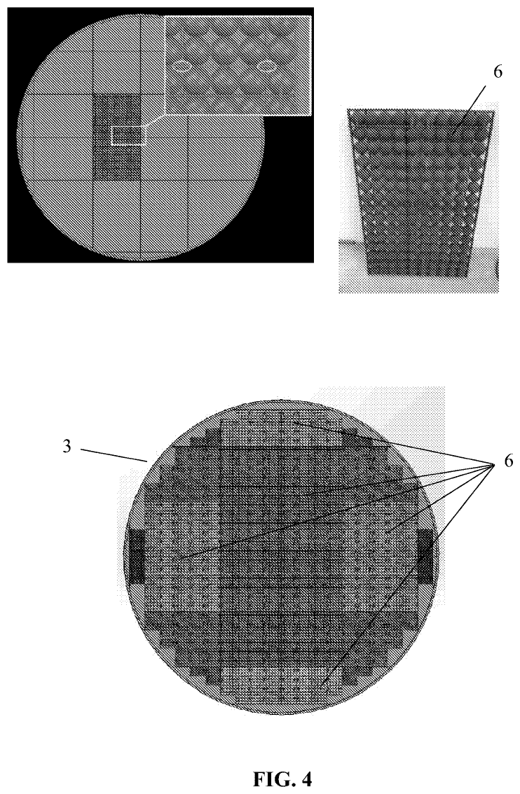

FIG. 4 schematically shows a plate of polymer spheres 6 mounted on metal bars and a plurality of plates 6 applied to the pelletizing disk 3 of the pelletizing device 10.

Preferably, the bottom wall of the pelletizing disk 3 is covered by a plurality of polymeric ball plates 6 mounted with steel bars to reduce the weight of the bottom layer of the pelletizing disk 3.

Still in its preferred configuration, the polymeric spheres that make up the polymeric sphere plates 6 are hollow, to reduce the weight of the pelletizing disk 3 and, consequently, generate a reduction in the energy consumption of the pelletizing device 10. In this preferred configuration, the polymeric spheres are manufactured by additive manufacturing processes, preferably using the three-dimensional printing process, so that the polymeric spheres are printed in rows with slots for assembly into modules on the polymeric sphere plates 6. These fittings, in their most preferred configuration, consist of male and female fittings, helping to connect the rows of polymer spheres.

In addition to the fittings, still in their preferred configuration, the polymeric spheres that make up the polymeric sphere plates 6 comprise a ledge with a hole that joins the polymeric spheres and allows the steel bars to pass through, making it possible to join the rows of polymeric spheres through both the fittings and the protrusions with the steel bar passages, forming the polymeric sphere plates 6 through this association of the rows of polymeric spheres, see FIG. 4.

The polymeric ball plates 6 are fixed to the bottom wall of the pelletizing disk 6, in their preferred configuration, by welding the steel bars to the bottom wall of the pelletizing disk 6. by welding the steel bars to the bottom wall of the pelletizing disk 6, ensuring that the polymeric ball plates 6 do not dissociate during movement.

Still in its preferred configuration, to assist in this fixation and prevent the material from accumulating in the space defined between the polymeric spheres of the polymeric sphere plates 6, damaging the formation of the base layer of material, an expansive adhesive material is applied, more specifically foam. expanding layer of PU or any other material capable of filling the empty spaces that may exist between the polymeric spheres, during the fixation of the polymeric sphere plates 6, helping to reduce weight and fix this component next to the pelletizing disc 3.

In alternative configurations, the polymeric ball plates 6 can be attached simply by applying the expanding foam, without the need to weld the steel bars to the bottom wall of the pelletizing disc 3. The polymeric ball plates 6 can be attached to the bottom wall of the pelletizing disk 3, and can be attached by means other than those described in this report.

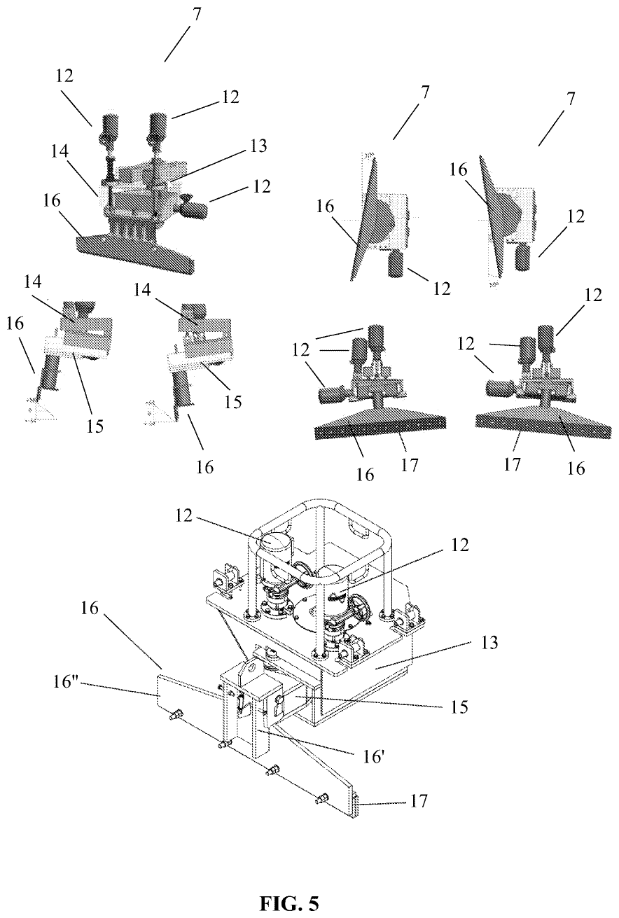

FIG. 5 schematically illustrates an adjustable scraper module 7 of the material pelletizing device 10. The adjustable scraper modules 7 can be attached to the pelletizing disk 3. Each adjustable scraper module 7 of the plurality of adjustable scraper modules 7 includes a scraper blade 16. Each adjustable scraper module 7 is configured to move the scraper blade 16 in three angular directions.

Preferably, each adjustable scraper module 7 of the plurality of adjustable scraper modules 7 further comprises three linear actuators 12 coupled to the scraper blade 16. The scraper blade 16 comprises a metal structure with a central portion 16′ for attachment to the linear actuators 12 and an elongated lower portion 16″ to which a scraping stone 17 is attached, which is in direct contact with the material on the pelletizing disk 3.

The linear actuators 12 can be coupled to electric actuators. In this embodiment, the linear actuators 12 convert the rotary movement of the electric actuators into a linear movement that adjusts the position of the scraper blade 16. This adjustment of the position of the scraper blade 16 is essential to adjust its height, angle in relation to the vertical axis and angle in relation to the horizontal axis, allowing it to interfere with the productivity and efficiency of the pelletizing device 10.

Since the wear of the scraping stone 17 arranged in contact with the material on the pelleting disc 3 is not homogeneous, this position adjustment of the scraper blade 16 also allows this wear in specific regions of the scraping stone 17 to be compensated, increasing the useful life of this component and, consequently, helping productivity due to less frequent equipment downtime for replacement.

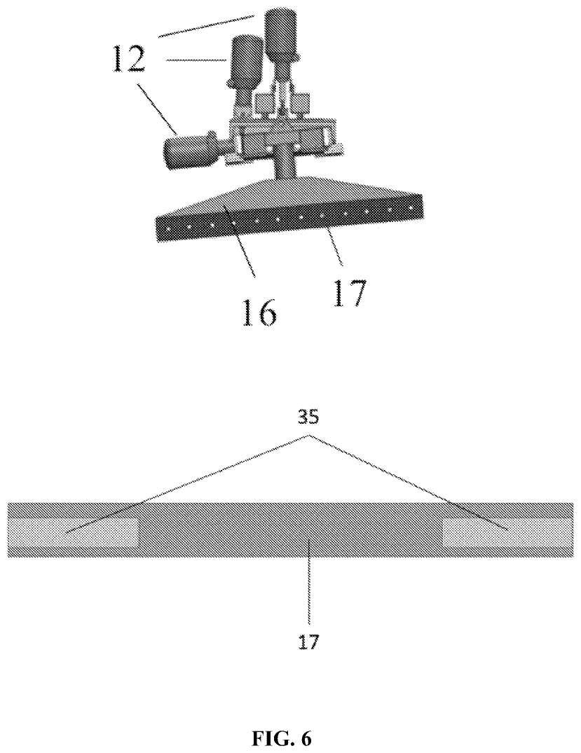

In order to gain a better understanding of the inhomogeneous wear of the scraping stone 17 in its preferred configuration, it comprises at least two sacrificial sensors 35 for monitoring its wear. The sacrificial sensor 35 is fixed at each distal end of the scraping stone 17, since most of the wear on the scraping stone 17 occurs at its ends, as shown in FIG. 6.

The sacrificial sensor 35 consists of an electronic circuit capable of varying the impedance when it is worn together with the scraping stone 17. Therefore, in order to have information on the variation of this impedance, it is necessary to use an electronic device to collect this data, which can be common to the electronic control device of the platooning device of the present invention.

From the data of the sacrificial sensor 35, automatic control can be implemented to correct the position of the scraper blade by the linear actuators 12, when there is wear in the operation of the scraping stone 17. Furthermore, the three linear actuators 12 are supported by a frame 13. Housing 13 is the fixed structural element of adjustable scraper module 7. Preferably, housing 13 is made from welded structural steel plates and has machined elements secured by bolts or locking pins. This housing 13, still in its preferred configuration, comprises a 13′ angled bottom side wall corresponding to the rack 5 on which it is installed, enabling a precise fit between the adjustable scraper module 7 and the rack 5 of the pelletizing device 10.

In this way, when it is necessary to replace the adjustable scraper module 7 or carry out its initial installation, it is lifted by lifting equipment and positioned on the stand 5, so that the angled bottom side wall 13′ of the housing 13 helps when fitting and positioning the adjustable scraper module 7 next to the easel 5.

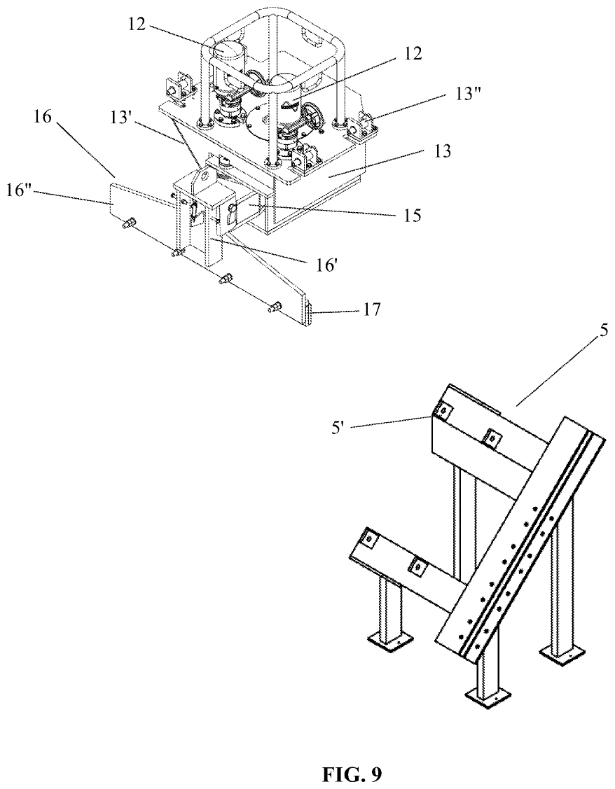

In addition to the angled bottom side wall 13′, the housing 13 of the adjustable scraper module 7 comprises side latches 13″ with spring pins that are configured to enter eyelets 5′ of the support on the easel 5, as illustrated in FIG. 9, enabling an association and practical dissociation of the adjustable scraper module 7 with the easel 5 when it is necessary to replace it as a whole.

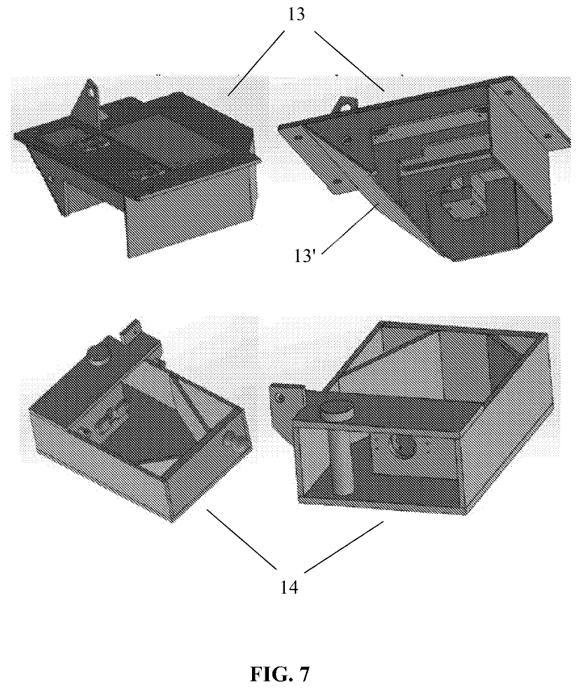

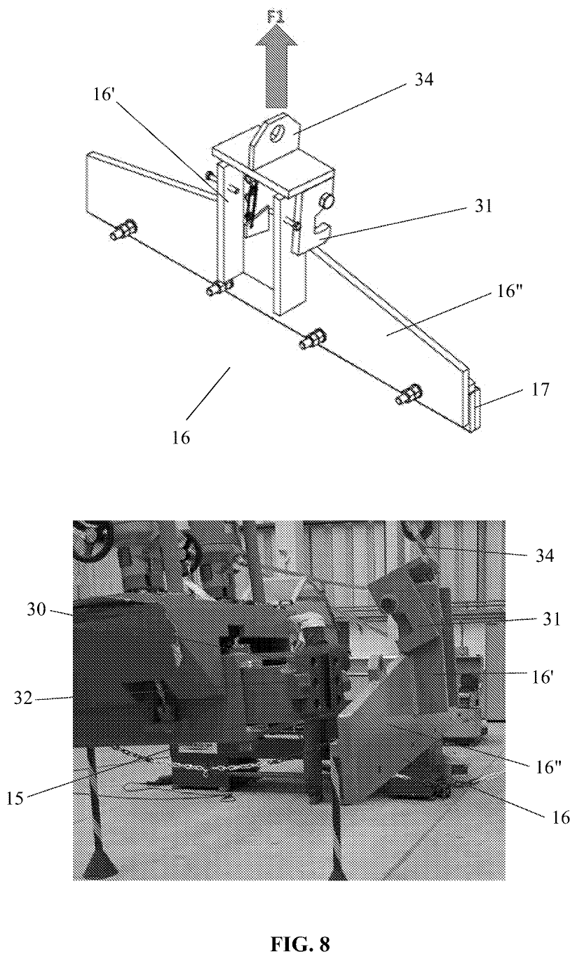

FIG. 7 shows a schematic illustration of the housing 13 and table 14 of the adjustable scraper module 7 of the pelletizing device materials. FIG. 8 shows the head 15 and scraper blade 16 of the adjustable scraper module 7 of the material pelletizing device 10 emphasizing the quick-lock mechanism.

The scraper blade 16 of each adjustable scraper module 7 of the plurality of adjustable scraper modules 7 can be coupled to a head 15, wherein the head 15 can be pivotably coupled to a table 14. In this embodiment, the head 15 is a movable component that supports the scraper blade 16 to carry out the scraper blade's top angle adjustment movement.

In addition, table 14 is a movable component that provides height and tilt control and couples head 15 to housing 13, allowing angular movement of head 15. The head 15 of the housing 13 and the central portion 16′ of the scraper blade 16, comprise a quick-lock mechanism, which allows easy replacement of the scraper blade 16 of the adjustable scraper module 7. It is easy to replace the scraper blade 16 of the adjustable scraper module 7 when its scraper stone 17 wears out.

In its preferred configuration, this quick-lock mechanism consists of a tongue-and-groove wedge fitting, such that the head 15 comprises a wedge-shaped conical slot 30 and the central portion 16′ of the scraper blade 16 comprises a projection corresponding to the conical slot 30 of the head 15. Still in its preferred configuration, the quick-lock mechanism also comprises side hooks 31 arranged on the central portion 16′ of the scraper blade 16, which correspond to the side lugs 32 of the head 15, guaranteeing a lock when the engagement is complete.

These side hooks 31 are equipped with a spring mechanism 33 associated with a lifting eye 34 of the central portion 16′ of the scraper blade 16, so that, when the scraper blade 16 is lifted by means of the lifting eye 34 for its replacement, the side hooks 31 are moved and dissociated from the side projections 32 of the head 15, allowing the scraper blade 16 to slide vertically in relation to the head 15 and the male and female fitting to be undone, performing the quick and practical dissociation of the scraper blade 16 for replacement, see FIG. 8.

Likewise, when it is necessary to install a new scraper blade 16, it is enough for it to have the projection of its central portion 16′ inserted into the conical slot 30 of the head 15, so that the gravitational force causes the fitting to occur and the locking occurs through the lateral hooks 31.

In alternative configurations, the quick lock mechanism may comprise elements other than the male and female fitting and side hook locks 31, it being only essential that the scraper blade 16 can be dissociated and associated with the head 15 for replacement after wear. of your scraping stone 17.

The linear actuators 12 of the adjustable scraper modules 7 of the material pelleting device 10, in their preferred configuration, comprise communication modules that allow them to be activated and adjusted remotely and in real time, enabling the position of the scraper blade 16 to be adjusted. changed remotely in a control room or on a local panel equipped with an HMI-Human Machine Interface. In addition, these linear actuators 12, still in their preferred configuration, include built-in sensors that make it possible to identify the current position of the scraper blade 16, as well as the condition of each of the linear actuators 12, such as, but not limited to, temperature, current, vibration, torque and others. This makes it possible to quickly identify faults in these components.

In this way, by means of the adjustable scraper modules 7 of the material pelletizing device 10, it is possible to control the scraper blade 16 remotely and in real time in a control room or another location, since the linear actuators 12 include communication modules for remote control.

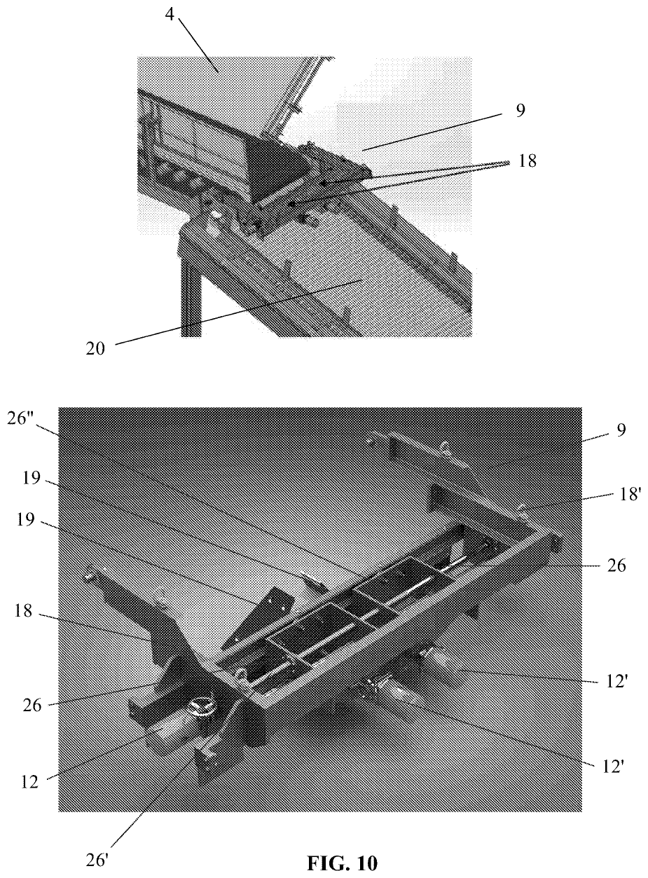

FIG. 10 shows a roller screen 20 and a deflector element 9 of the material pelletizing device 10.0 deflector element 9 comprises a frame 18 which is coupled to deflector plates 19 adjustable by means of adjustment mechanisms 26. These deflector plates 19, in their preferred configuration, are fitted with a coating layer of non-stick material, which is essential for preventing the accumulation of material on their contact face and, consequently, increasing the efficiency of the pellet distribution process. Structure 18 of deflector element 9 also includes 18′ lifting eyes distributed on it to enable the equipment to be lifted when it needs to be removed for maintenance.

Furthermore, still in its preferred configuration, the structure 18 of the deflector element 9 is fixed by means of a pivoting mechanism, so that it is possible to carry out a pivoting movement through the lifting with its lifting eyes 18′, preventing the entire deflector element 9 is removed to perform maintenance on this equipment. In this way, through this pivoting mechanism, it is possible to vary the orientation of the structure 18 from horizontal to vertical without the need for complete removal, helping with maintenance and access to the other components of the deflector element 9.

Preferably, the deflector element 9 is configured to move the deflector plates 19 in the direction transverse to the material flow and pivot the deflector plates 19, adjusting both their position with respect to the horizontal axis and their angulation. The adjustment mechanism 26, in its preferred configuration, consists of a spindle assembly 26′ passing through a troller 26″ and supported by bearings on the frame 18 of the deflector element 9 to move the deflector plates 19 in the longitudinal direction, comprising a set of 26″ spindles and 26″ trolleys for each deflector plate 19, to ensure independent movement of each deflector plate 19 in relation to the other.

Still in its preferred configuration, the troller 26″ moves linearly by means of wheels fixed to its structure and supported on the structure 18 of the deflector element 9, so that, when driven by the spindle 26′, these supported wheels guide the troller 26″ together with the deflector plate 19 along the structure 18. In alternative configurations, the 26″ troller can be guided by components other than the wheel resting on the 18″ frame, such as linear guides.

Since the movement of each of the trollers 26″ of the deflector plates 19 is independent, that is, each one is motivated by a linear actuator 12 and a spindle 26′, they have, in their preferred configuration, protection mechanisms. collision via programming, preventing them from colliding during operation. Such collision protection mechanisms, in alternative configurations, can be physical barriers.

This deflector element 9 is essential for distributing the flow of pellets before they enter the roller screen 20, to guarantee efficient screening and greater homogeneity of the wear on the rollers 22 of the roller screen 20. The adjustment mechanisms 26 of the deflector element 9 are also driven by means of linear actuators 12, which can be remotely operated to adjust both the position and angulation of the deflector plates 19. In addition to the adjustment mechanisms 26, the deflector element 9 also comprises two angular actuators 12′ associated with each deflector plate 19 to adjust its angular position, see FIG. 10.

In this way, it is possible to position the deflector plates 19 by means of the adjustment mechanisms 26 and the angular actuators 12′ so that they are in contact with the pellets coming from the discharge ramp 4 of the pelletizing disk 3, distributing the pellets evenly on the roller sieve 20.

Preferably, the material pelletizing device 10 further comprises a roller sieve 20 including a plurality of rollers 22. Even more preferably, the plurality of rollers 22 are coated to reduce wear and adhesion of the material as it passes over the surface of the rollers 22.

In this embodiment, rollers 22 are coupled to roller bearings 23 and a roller distance adjustment element 25 is coupled between roller bearings 23.

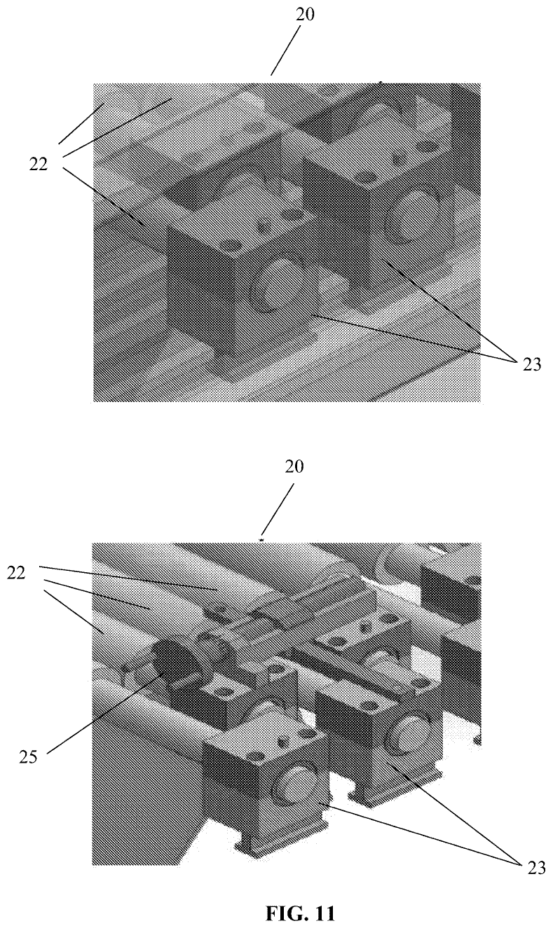

The roller distance adjustment element 25 is configured to adjust the distance between the faces of the rollers 22. FIG. 11 shows a schematic of the roller sieve 20 of the material pelletizing device 10.

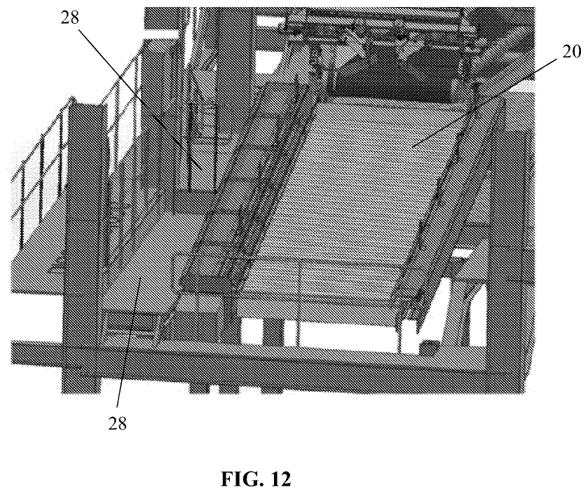

In addition, FIG. 12 illustrates access platforms 28 of the material pelletizing device 10. Preferably, the access platforms 28 are arranged adjacent to the roller screen 20 to allow access to the side areas of the roller screen 20, where maintenance and assembly of the roller screen 20 can be carried out.

The present invention is advantageous in that the material pelletizing device 10 provides precise control of the movement of the scraper blades 16 over the pelletizing disk 3 in three angular directions by means of the actuation of the adjustable scraper modules 7.

Furthermore, by providing automated control of the adjustable scraper modules 7, the present invention reduces human intervention in the operation and maintenance of the pelletizing disk 3.

Another advantage of the present invention is to increase the level of reliability of components with a shorter mean time to failure and to reduce the average time to repair the components of the pelletizing device 10.

In this way, the present invention increases the total availability of the pelletizing disks 3 while maintaining their higher performance, generating productivity gains of up to 5% in pelletizing operations. It also reinforces the fact that this invention is not limited to the configurations/embodiments described above.

1. Material pelletizing device characterized n that it comprises:
a pelletizing disc tiltable and rotatable; and
a plurality of adjustable scraper modules attachable to the pelletizing disc, wherein each adjustable scraper module of the plurality of adjustable scraper modules includes a scraper blade and is configured to rotate the scraper blade in three angular directions.

2. Device, according to claim 1, characterized in that the plurality of adjustable scraper modules comprises from 2 to 10 adjustable scraper modules, each adjustable scraper module of the plurality of adjustable scraper modules additionally comprising three linear actuators coupled to the scraper blade, wherein the three linear actuators are coupled to electrical actuators, and wherein the three linear actuators are supported by a housing.

3. Device, according to claim 1, characterized in that the scraper blade of each adjustable scraper module of the plurality of adjustable scraper modules is coupled to a head, wherein the head is so coupled pivotable to a table.

4. Device, according to claim 3, characterized in that the coupling of the scraper blade with the head is carried out by means of a quick-lock mechanism consisting of a male and female fitting.

5. Device, according to claim 4, characterized in that the quick-locking mechanism comprises a conical slot in a wedge shape arranged in the head and a projection corresponding to the conical slot on the scraper blade to form the male and female fitting, also comprising side hooks on the scraper blade scraper, which correspond to side projections arranged on the head.

6. Device, according to claim 5, characterized in that the side hooks are equipped with a spring mechanism associated with a lifting eye arranged on the scraper blade to move the side hooks as the scraper blade is lifted.) using the lifting eye.

7. Device, according to claim 1, characterized in that it further comprises a rack attachable to the pelletizing disc, wherein the rack is configured to accommodate the plurality of adjustable scraper modules.

8. Device, according to claim 7, characterized in that the housing of the adjustable scraper module comprises an angled bottom side wall with an angle corresponding to an angle of the trestle to fit and accommodate the adjustable scraper module on the trestle. with an angle corresponding to an angle of the trestle in order to fit and accommodate the adjustable scraper module on the trestle.

9. Device, according to claim 8, characterized in that the housing comprises side latches with spring pins that are configured to enter eyebolts arranged on the trestle and carry out the fixing between these components.

10. Device, according to claim 1, characterized in that it further comprises a discharge ramp, wherein the discharge ramp comprises at least one motor-vibrator.

11. Device, according to claim 1, characterized in that the pelletizing disc comprises a bottom wall covered by a plurality of polymeric ball plates.

12. Device, according to claim 11, characterized in that the polymeric sphere plates are composed of hollow polymeric spheres manufactured by an additive manufacturing process, associated using male and female fittings and steel bars to form the polymeric sphere plates.

13. Device, according to claim 1, characterized in that it additionally comprises a deflector element that includes a structure coupled to deflector plates adjustable longitudinally through independent adjustment mechanisms driven by means of linear actuators.

14. Device, according to claim 13, characterized in that the deflector element also comprises angular actuators associated with the deflector plates to adjust their angle, allowing independent adjustment for each deflector plate.

15. Device, according to claim 1, characterized in that the linear actuators and the angular actuators comprise a communication module that allows them to be remotely actuated and controlled.

16. Device, according to any claim 1, characterized in that it further comprises a roller sieve including a plurality of rollers.

17. Device, according to claim 16, characterized in that the rollers are coupled to roller bearings, wherein a roller distance adjustment element is coupled between the roller bearings.

18. Device, according to claim 17, characterized in that the roller bearings are fixed by means of lower fixed bars and to the upper portion of the roller screen.

19. Device, according to claim 1, characterized in that it additionally comprises access platforms adjacent to the roller sieve.

20. Device, according to claim 1, characterized in that it additionally comprises sacrificial sensors coupled to the scraping stone.
